(19) United States
(12) Patent Application Publication
(10) Pub. No.: US 2003/0138666 A1
(43) Pub. Date: Jul. 24, 2003

(54) Magnetic recording medium and magnetic storage device

(75) Inventors: Takashi Gouke, Higashine (JP); Chiaki Okuyama, Kawasaki (JP); Akira Kikuchi, Higashine (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/196,639

(22) Filed: Jul. 16, 2002

(30) Foreign Application Priority Data
Jan. 24, 2002 (JP) 2002-016135

(51) Int. Cl. G11B 5/72

(52) U.S. Cl. 428/694 T; 428/694 TP; 428/695

(57) ABSTRACT

A magnetic recording medium includes a substrate; and a recording layer and a protection layer which are provided upward of the substrate, wherein the recording layer includes a magnetic layer; and the magnetic layer includes an additive chemical element selected from a CoCrPt group alloy and a group comprising and chemical elements in which a standard electrode electric potential is negative and platinum group chemical elements other than Pt.

### BACKGROUND OF THE INVENTION

1. Field of the Invention

The present invention generally relates to magnetic recording media used for magnetic storage devices and the magnetic storage devices, and more particularly, to a magnetic recording medium and a magnetic storage device including the magnetic recording medium by which corrosion resistance of the magnetic recording medium and making a protection layer thin are improved so that recording at a high density can be achieved.

2. Description of the Related Art

Recently, as information processing technology is improved, it has been required for a magnetic storage device to have a large storage capacity. There is a method for increasing the number of recording magnetic media installed in the magnetic storage device in order to increase the storage capacity. However, there is a limitation of the number on the recording magnetic media installed in the magnetic storage device due to a space limitation of the magnetic storage device. Accordingly, it is difficult to meet the requirement to increase the storage capacity by the above mentioned method. Hence, it is essential that the magnetic recording medium enables recording at a high density. Here, as means for recording at high density on the magnetic recording medium, there is means for increasing a bits per inch and track density of the magnetic recording medium. The bits per inch can be increased mainly by an improvement of the output of a reproducing head used for reading out the information by a magnetic head.

Meanwhile, there is “W₅₀”, an isolated pulse width at 50 percent of pulse amplitude, as an index of the ability of the magnetic recording medium for improving the bits per inch. Generally, it is known that the smaller the value of W₅₀ is, the more capable of recording at high density the magnetic recording medium is.

The value of W₅₀ is calculated by the following formula in a case where the gap length of the reproducing head having a magnetic resistance element for reading out by the magnetic head is expressed as “g”, the magnetic spacing between the reproducing head and the recording layer of the magnetic recording medium is expressed as “d”, and the magnetic transition width of the magnetic recording medium is expressed as “a”.

$${W}_{50} = 2 {( {( g / 2 )}^{2} + {( d + a )}^{2} )}^{1 / 2}$$

According the above mentioned formula, it is necessary to make the gap length of the reproducing head “g” small, make the magnetic transition width “a” small, and make the magnetic spacing “d” small, in order to make the value of W₅₀ small, namely in order to accomplish recording at high density.

As a method for making the magnetic spacing “d” small, there is a method for making the thickness of a protection layer formed on the recording layer of the magnetic recording medium, mainly a carbon group protection layer, thin.

However, if the layer thickness of the protection layer becomes thin, a part of the recording layer where the protection layer does not cover, namely a covering defect part, is partially generated partially so that the covering ability of the protection layer against the recording layer declines. In this case, if moisture in the air is absorbed by or condenses on the surface of the protection layer, the moisture reaches the recording layer through the covering defect part so that corrosion is generated. As an example of a mechanism of the corrosion, there is an oxidation reaction (anode reaction) of Co in which Co included in the recording layer dissolves in the moisture as a Co ion by a restoration (cathode reaction) of a metal ion, a hydrogen ion or an oxide existing in the moisture leading to the recording layer. Once the corrosion is generated, Co dissolves so that the amount of Co is reduced. As a result of this, a saturated magnetic amount and a remanent magnetization amount corresponding to the reduced amount of Co are reduced. In this case, a defect at the time of recording and reproducing of the magnetic recording medium, such as not recording information completely or partial declination of output voltage, is generated. Because of this, the reliability of the magnetic recording medium declines remarkably.

An alloy, in which less than 10 at % of a chemical element such as Ta or B promoting a segregation of Cr is added to CoCrPt, is used as a magnetic material for the recording layer of the magnetic recording medium. It is known that corrosion resistance of the recording layer is improved by increasing contents of Cr and Pt.

Japanese Laid-Open Patent Application No. 11-154321 discloses a magnetic recording medium by which corrosion resistance of the recording layer is improved. The magnetic recording medium is formed by Co-based alloy magnetic layers including a first additive element of at least one kind selected from a group consisting of Pt and Ir, a second additive element of at least one kind selected from a group consisting of Ti, Zr, Hf, V, Nb, Ta, Cr, Mo, W, Ge and Si, oxide, Co in a remaining part, via nonmagnetic metal such as Cr formed on a nonmagnetic substrate.

However, if the contents of Cr in the recording layer increases, the saturation magnetization amount in the recording layer decreases so that the output voltage is reduced. Furthermore, if the content of Pt in the recording layer increases, the distribution of the diameter of magnetic particles consisting of the recording layer becomes wide and an exchange mutual action in the magnetic particles increases Hence, a medium noise with regard to a reproducing signal increases so that the S/N ratio is reduced.

In addition, since an oxide is included in the recording layer of the magnetic recording medium disclosed in the Japanese Laid-Open Patent Application No. 11-154321, coercivity of the magnetic recording medium is reduced. Furthermore, the stability of the saturation magnetization amount in the recording layer is reduced due to a thermal influence at the time of depositing the recording layer. In addition, the medium noise with regard to the reproducing signal increases so that the S/N ratio is reduced.

### SUMMARY OF THE INVENTION

Accordingly, it is a general object of the present invention to provide a novel and useful magnetic recording medium and a magnetic storage device including the magnetic recording medium in which one or more of the problems described above are eliminated.

Another and more specific object of the present invention is to provide a magnetic recording medium by which corrosion resistance of the magnetic recording medium and making a protection layer thin are improved so that recording at a high density can be achieved. Another object is to provide a magnetic storage device comprising the magnetic recording medium and having a large amount of storage capacity.

The above objects of the present invention are achieved by a magnetic recording medium, including a substrate; and a recording layer and a protection layer that are provided upward of the substrate, wherein the recording layer includes a magnetic layer; and the magnetic layer includes a CoCrPt group alloy and an additive chemical element selected from a group comprising chemical elements in which a standard electrode electric potential is negative and platinum group chemical elements other than Pt.

According to the present invention as described above, corrosion resistance of the magnetic recording medium and making a protection layer thin are improved so that magnetic spacing can be reduced. As a result of this, recording at a high density can be achieved.

The magnetic layer may include 0.01 at % through 30 at % of the additive chemical element.

This is because the magnetic layer loses its magnetic nature in a case where the amount of the additive chemical element in the magnetic layer exceeds 30 at %.

The recording layer may include a plurality of magnetic layers, and a non-magnetic connection layer is provided between each of the magnetic layers.

According to the present invention as described above, thermal stability of a recording bit written in the recording layer can be improved.

The protection layer may have a layer thickness of 0.5 nm through 10 nm.

According to the present invention as described above, the magnetic spacing can be reduced so that an ability of recording, reproducing, and analysis of the magnetic recording medium can be improved.

The magnetic layer may include the CoCrPt group alloy and the additive chemical element selected from a group comprising P, Ru, Os, Rh, Ir, Pd, Ba, Sr, Ca, Ti, Mn, Fe, Ni, and La.

The above objects of the present invention are achieved by a magnetic storage device including a magnetic recording medium, the magnetic recording medium including a substrate, and a recording layer and a protection layer that are provided upward of the substrate, wherein the recording layer includes a magnetic layer, and the magnetic layer includes a CoCrPt group alloy and an additive chemical element selected from a group comprising chemical elements in which a standard electrode electric potential is negative and platinum group chemical elements other than Pt.

According to the present invention as described above, the magnetic storage device can have the magnetic recording medium by which corrosion resistance of the magnetic recording medium and making a protection layer thin are improved so that magnetic spacing can be reduced and recording at a high density can be achieved. Hence, it is possible for the magnetic storage device to have a large storage capacity.

Other objects, features, and advantages of the present invention will become more apparent from the following detailed description when read in conjunction with the accompanying drawings.

### BRIEF DESCRIPTION OF THE DRAWINGS

FIG. 1 is an illustration showing a structure of stacked layers of a magnetic recording medium of the first embodiment of the present invention;

FIG. 2 is an illustration showing a structure of stacked layers of a magnetic recording medium of the second embodiment of the present invention;

FIG. 3 is an illustration showing a structure of stacked layers of a magnetic recording medium of a comparative example for comparing with the present invention;

FIG. 4 is a graph showing a relation between an amount of dissolving out of Co and a layer thickness of a DLC protection layer with respect to the magnetic recording media of the first embodiment and the comparative example shown in FIG. 3;

FIG. 5 is a table showing a relation between an amount of dissolving out of Co and a layer thickness of a DLC protection layer with respect to the magnetic recording media of the first embodiment, the second embodiment, and the comparative example shown in FIG. 3;

FIG. 6 is a cross sectional view showing a part of one example of a magnetic storage device of the present invention; and

FIG. 7 is a plan view showing a part of the magnetic storage device of FIG. 6.

### DETAILED DESCRIPTION OF THE PREFERED EMBODIMENTS

A description will now be given, with reference to the drawings, of the first and second embodiments of the present invention. The first embodiment is related to a magnetic recording medium in which a recording layer has one magnetic layer. The second embodiment is related to a magnetic recording medium in which the recording layer has two magnetic layers and one non-magnetic connection layer put between each of the magnetic layers.

<First Embodiment>

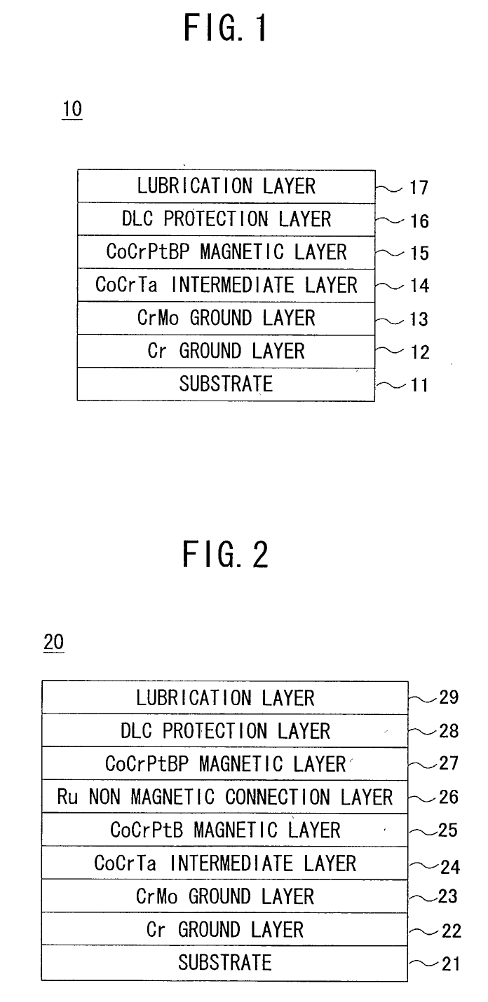

FIG. 1 is an illustration showing a structure of stacked layers of a magnetic recording medium 10 of the first embodiment of the present invention.

An NiP layer is coated on a surface of the substrate 11 which is non-magnetic and the magnetic recording medium 10 may be texture-processed. The magnetic recording medium 10 has a structure in which a Cr ground layer 12, a CrMo ground layer 13, a CoCrTa intermediate layer 14, a CoCrPtBP magnetic layer 15 and a DLC (hydrogen carbon) protection layer 16 are stacked on the substrate 11, from the substrate 11 in order.

Next, a preferable embodiment with regard to manufacturing the magnetic recording medium 10 of the first embodiment of the present invention shown in FIG. 1 will be described.

An Al substrate which is non-magnetic or a glass substrate may be used as a substrate 11 of the magnetic recording medium 10. The substrate 11 is not limited to the above mentioned substrate. Rather, a plastic substrate may be used as the substrate 11 for example. In this embodiment, an Al substrate is used as the substrate 11.

The NiP layer is coated on a surface of the substrate 11 by non-electrolysis plating. The substrate 11 may be mechanical-texture-processed or laser-texture-processed like a concentric circle. However, a texture-process is not always required. In this embodiment, the substrate 11 is mechanical-texture-processed.

The respective layers 11 through 16 of the magnetic recording medium 10 may be formed by a thin film deposition technology with a sputtering apparatus. More particularly, in this embodiment, deposition is carried out by a DC magnetron sputtering method. After a sputter room is evacuated until the room has a vacuum degree of less than 4*10-5 Pa prior to the deposition of respective layers, Ar gas is led in and a deposition is implemented in a state where the sputter room keeps having a vacuum degree of 0.67 Pa.

Before the Cr ground layer 12 is deposited, the substrate 11 is heated to more than 200 degrees centigrade in order to clean impurities adhering on the substrate 11 and control a crystal orientation. When the substrate 11 is heated to more than 270 degrees centigrade, NiP, which is amorphous, is crystallized and has magnetism. Therefore, in order to control the above mentioned crystallization and magnetism, it is preferable for the substrate to have a temperature of 200 through 270 degrees centigrade. In this embodiment, the substrate has a temperature of 220 degrees centigrade.

Next, the Cr ground layer 12 is deposited on the substrate 11. It is preferable for the Cr ground layer to have a layer thickness selected in a range of 2 through 7 nm. In a case where the Cr ground layer 12 has a layer thickness of less than 2 nm, the crystalline of the Cr ground layer 12 is not sufficient so that the crystal orientation in an intra-surface direction of c-axis of the magnetic layer 15, which is a magnetocrystalline easy axis of the c-axis, declines. In a case where the Cr ground layer 12 has a layer thickness greater than 7 nm, a crystal particle in the Cr ground surface 12 grows. As a result of this, the volume of a magnetic particle in the magnetic layer 15 increases so that a medium noise at the time of reproducing increases. In this embodiment, the Cr ground layer 12 has layer thickness of 5 nm.

The Cr group alloy ground layer 13 having a larger lattice constant than Cr is formed on the Cr ground layer 12. Hence, an adjustment of a surface space of a crystal lattice with the magnetic layer 15 becomes well so that the crystal orientation in the intra-surface direction of the c-axis of the magnetic layer 15, which is the magnetocrystalline easy axis of the magnetic layer 15, becomes well. It is preferable that the Cr group alloy ground layer 13 includes at least one chemical element selected from a group consisting of W, V, and Mo and having a crystal structure formed by a hcp structure (hexagonally closed-packed structure). In this embodiment, CrMo is used for the Cr group alloy ground layer 13 and the Cr group alloy ground layer 13 having a layer thickness of 2 nm is deposited.

The CoCrTa intermediate layer 14 is deposited on the Cr group alloy ground layer 13. A Co-based alloy having the hcp structure is used in the intermediate layer 14. It is preferable that a chemical element selected from a group of Cr, Ta, Mo, Mn, Re, and Ru is included in the Co-based alloy. Because of this, it is possible to improve the crystal orientation in the intra-surface direction of the c-axis of the magnetic layer 15. It is also preferable for the intermediate layer 14 to have a layer thickness selected in a range of 0.3 nm to 5 nm. This is because in a case where the intermediate layer 14 has a layer thickness less than 0.3 nm, the crystal of the intermediate layer 14 is not sufficient so that the crystal orientation in the intra-surface direction of the c-axis of the magnetic layer 15 does not improve. This is also because in a case where the intermediate layer 14 has a layer thickness greater than 5 nm, the reduction of the ability of resolution is caused. In this embodiment, CoCrTa is used as the intermediate layer 14 and the intermediate layer 14 having a layer thickness of 1 nm is deposited.

The magnetic layer 15 is deposited on the intermediate layer 14 as a recording layer.

A magnetic material including at least one additive chemical element selected from a group consisting of chemical elements having a standard electrode electric potential being negative and platinum group elements other than Pt in the CoCrPt group alloy, such as CoCrPt, CoCrPtTa in which Ta is added to CoCrPt, or CoCrPtB in which B is added to CoCrPt, is used in the magnetic layer 15. Here, for example P, Li, Rb, K, Cs, Ba, Sr, Ca, Na, La, Ce, Mg, Th, Be, U, Al, Ti, Mn, Zn, Fe, Cd, Tl, Ni, Sn, Pb or S can be applied as a chemical element whose standard electrode electric potential is negative. In addition, for example, Ru, Os, Rh, Ir, or Pd can be applied as the platinum group chemical element other than Pt. It is preferable that a platinum group chemical element other than Pt that is not active in the chemical reaction, such as Ru, Os, Rh, Ir or Pd. is applied.

It is preferred that an added amount of the above mentioned added chemical element is 0.01 through 30 at % in a case where the entire magnetic material of the magnetic layer is expressed as 100 at %. When the amount of the added chemical element exceeds 30 at %, contents of Co in the magnetic layer is reduced to less than 70 at % so that the magnetic layer loses its magnetic nature. In addition, it is preferable that the added amount of the additive chemical element is between 1 at % and 30 at %. If the added amount of the added chemical element is less than 1 at %, it is not possible to obtain sufficient corrosion resistance. If the added amount of the additive chemical element exceeds 30 at %, the magnetic layer loses its magnetic nature.

In this embodiment, CoCrPtBP₅ in which 5 at % of P is added to CoCrPtB is used for depositing the magnetic film 15 so that tBr, which is the product of magnetic layer thickness and remanent magnetization becomes 6.0 nTm.

Next, the protection layer 16 is deposited on the magnetic layer 15. Carbon is included in the protection layer 16 as a main ingredient and hydrogen and nitrogen are added to the protection layer 16. The protection layer 16 has a layer thickness of between 0.5 nm and 10 nm. In this embodiment, a layer thickness of the DLC (hydrogenation carbon) protection layer is selected in a range of 0.5 nm through 10 nm for depositing.

A lubrication layer 17 is formed on the protection layer 16. The lubrication layer 17 is made of organic lubricant. The lubrication layer 17 has a layer thickness of 1.0 nm.

The magnetic recording medium is made by using the magnetic layer 15 made of CoCrPtBIr₅ in which 5 at % of Ir is added to CoCrPtB, under same condition as other above mentioned magnetic recording media.

<Second Embodiment>

FIG. 2 is an illustration showing a structure of stacked layers of a magnetic recording medium 20 of the second embodiment of the present invention. In this embodiment, two magnetic layers 25 and 27 as recording layers with one non-magnetic connection layer 26 put between the magnetic layers 25 and 27 are provided.

The magnetic recording medium 20 has a structure in which a Cr ground layer 22, a CrMo ground layer 23, a CoCrTa intermediate layer 24, a CoCrPtB magnetic layer 25, a Ru non magnetic connection layer 26, a CoCrPtBp magnetic layer 27, a DLC protection layer 28 and a lubrication layer 29 are stacked on the substrate 21, from the substrate 21 in order. The recording layer consists of the CoCrPtB magnetic layer 25, the Ru non-magnetic connection layer 26 and the CoCrPtBP magnetic layer 27.

If the Ru non-magnetic connection layer 26 has a layer thickness having a proper range, the magnetic layer 25 and the magnetic layer 27 are coupled anti-ferromagnetically so that it is possible to increase effective magnetic particle volume without increasing magnetic particle diameter. As a result of this, thermal stability of the recording bits written in the magnetic recording medium improves. The above mentioned technology is described in the Japanese Laid-Open Patent Application No. 2001-56925, for example.

Next, a preferable embodiment with regard to manufacturing the magnetic recording medium 20 of the second embodiment of the present invention shown in FIG. 2 will be described.

In elements forming the magnetic recording medium 20, the substrate 21, the Cr ground layer 22, the CrMo ground layer 23, the CoCrTa intermediate layer 24, the DLC protection layer 28 and the lubrication layer 29 can be produced as the same as the magnetic recording medium 10.

Furthermore, the magnetic layer 25 is deposited on the CoCrTa intermediate layer 24. CoCrPt is used for the magnetic layer 25. The same magnetic material in the magnetic layer of the first embodiment may be used in the magnetic layer 25. In this embodiment, 5 nm of the CoCrPtB magnetic layer is deposited.

The non-magnetic connection layer 26 is deposited on the magnetic layer 25. The non-magnetic connection layer 26 is made by Ru, Cr, a Ru alloys a Cr alloy or the like. It is preferable that the layer thickness of the non-magnetic connection layer 26 is selected in a range of 0.4 nm through 1.0 nm. By setting the above mentioned range as a layer thickness, the magnetic layer 25 and the magnetic layer 27 are coupled anti-ferromagnetically so that magnetization direction of the magnetic layers becomes anti-parallel each other. In this embodiment, 0.8 nm of the Ru layer is deposited.

The magnetic layer 27 is deposited on the non-magnetic connection layer 26. The magnetic layer 27 is almost the same as the magnetic layer 15 of the first embodiment. In this embodiment, CoCrPtBP₅ in which 5 at % of P is added to CoCrPtB so that 6.0 nTm of tBr is deposited. CoCrPtBIr₅ in which 5 at % of Ir is added to CoCrPtB is used for the magnetic layer 27 so that the magnetic recording medium is produced according to this embodiment.

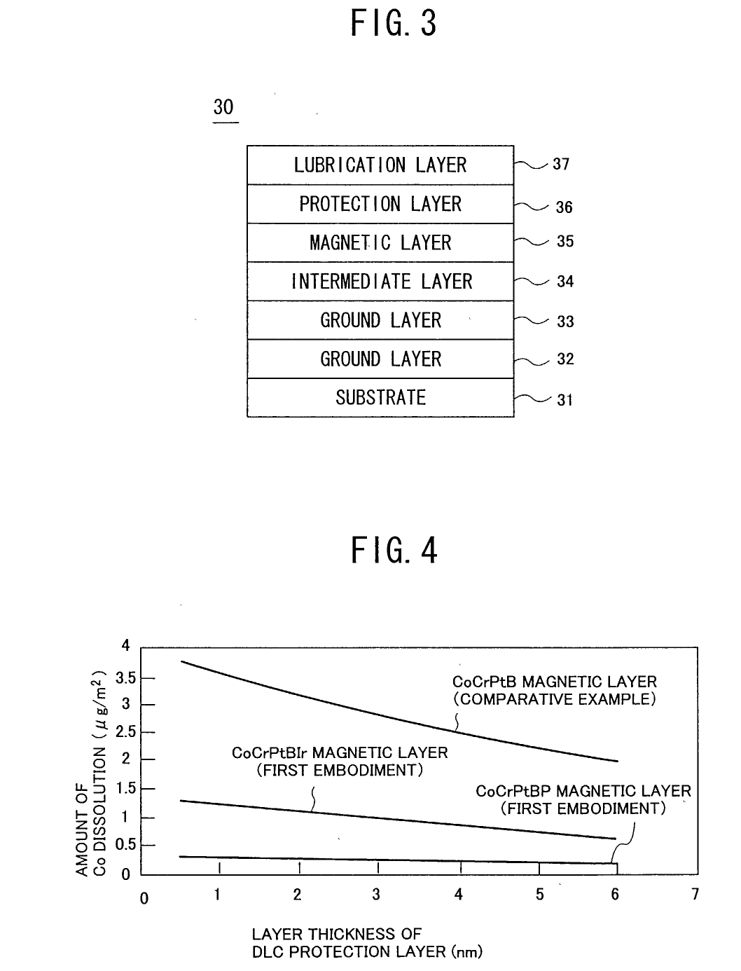

FIG. 3 is an illustration showing a structure of stacked layers of a magnetic recording medium of a comparative example for comparing with the present invention. The magnetic recording medium 30 has, as well as the magnetic recording medium 10 in the first embodiment, a structure in which a Cr ground layer 32, a CrMo ground layer 33, a CoCrTa intermediate layer 34, a CoCrPtB magnetic layer 35, a DLC protection layer 36 and a lubrication layer 37 are stacked on the substrate 31, from the substrate 31 in order. The magnetic recording medium 30 of the comparative example is the same as the magnetic recording medium 10 of the first embodiment other than that the magnetic material of the magnetic layer 35 is CoCrPtB.

Next, the above mentioned magnetic recording media are evaluated based on the following corrosion resistance test. In the test, 0.5 ml of nitrate liquid having 3% concentration is dropped on four points of the surface of the magnetic recording medium and the magnetic recording medium is left for one hour. A mass of a Co ion which is dissolved out into the nitrate liquid dropped on the magnetic recording medium surface is measured by an ICP-MS (Inductively Coupled Plasma Mass Spectroscopy) so that the Co ion mass (Co dissolution amount) in the nitrate liquid removed is used for the test. As described above, corrosion is generated based on dissolution of Co to the moisture absorbed on the surface of the protection layer of the magnetic recording medium due to a restoration of hydrogen ions contained in the moisture or the like and oxidation of Co contained in the magnetic layer. Therefore, it is possible to determine the corrosion resistance of the magnetic recording medium precisely by the test.

As a determination standard of the measurement test, if the amount of dissolution of Co is less than 2.5 μg/m², the test is regarded as passed, and if the amount of dissolution of Co exceeds 2.5 μg/m², the test is regarded as not-passed.

FIG. 4 is a graph showing a relation between the amount of dissolving out of Co and the layer thickness of a DLC protection layer with respect to the magnetic recording media of the first embodiment and the comparative example shown in FIG. 3.

As shown in FIG. 4, the CoCrPtB magnetic layer of the magnetic recording medium of the comparison example is not-passed if the layer thickness of the DLC protection layer has a layer thickness of less than 3 nm. On the other hand, when the layer thickness of the DLC protection layer is more than 0.5 nm, the magnetic recording medium of the CoCrPtBIn magnetic layer and CoCrPtBP magnetic layer of the first embodiment are passed.

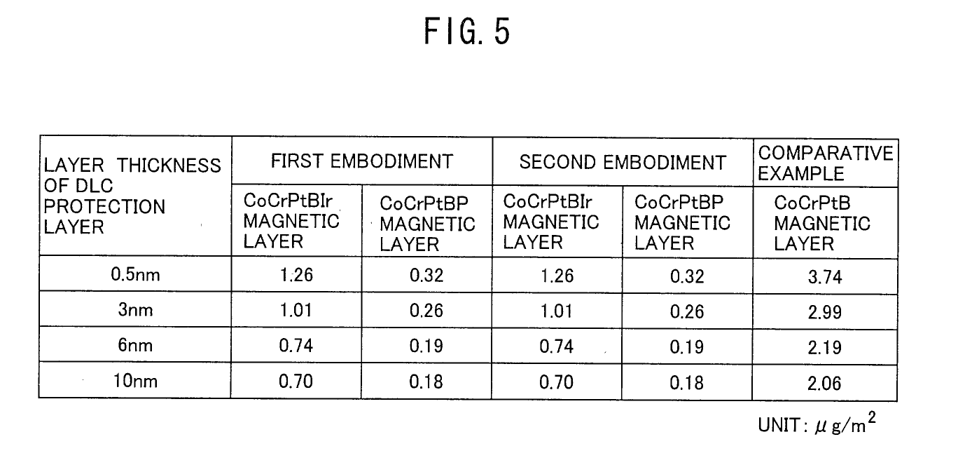

FIG. 5 is a table showing the relation between the amount of dissolving out of Co and the layer thickness of a DLC protection layer with respect to the magnetic recording media of the first embodiment, the second embodiment, and the comparative example shown in FIG. 3.

As shown in FIG. 5, the magnetic recording medium of the CoCrPtBIr magnetic layer and the CoCrPtBP magnetic layer of the first and second embodiments are passed when the layer thickness of the DLC protection layer is more than 0.5 nm.

Therefore, the corrosion resistance of the recording layer of the magnetic recording media of the first and second embodiments are improved. Therefore, it is possible to make the thickness of the protection film thin. As a result of this, it is possible to reduce the magnetic spacing so that it is possible to obtain a magnetic recording medium capable of recording at high density.

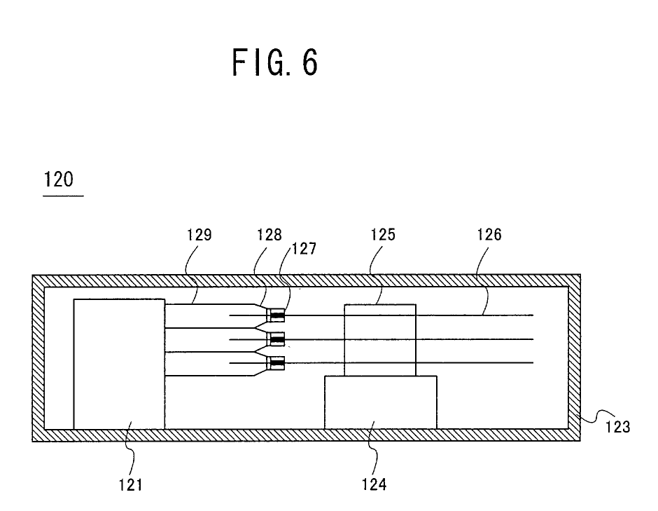

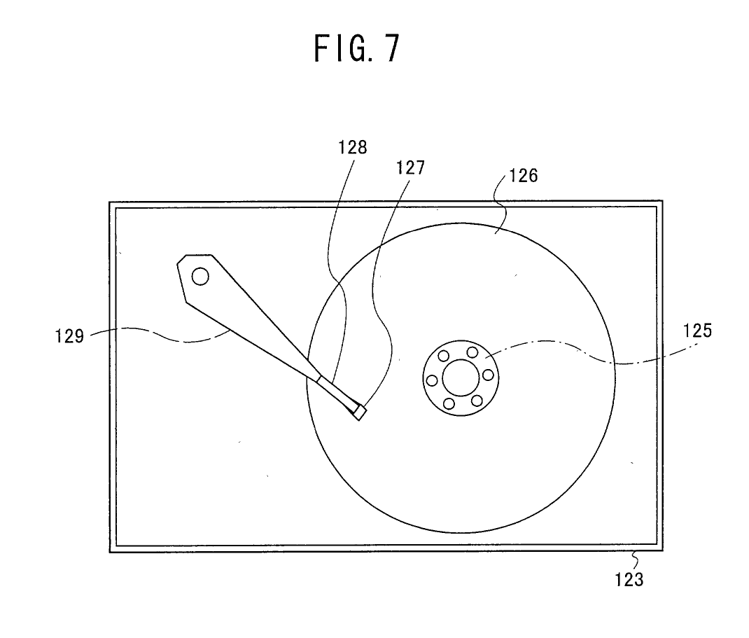

Next, one example of the magnetic storage device of the present invention will be described with FIGS. 6 and 7. FIG. 6 is a cross sectional view showing a part of one example of a magnetic storage device of the present invention. FIG. 7 is a plan view showing a part of the magnetic storage device of FIG. 6.

As shown in FIGS. 6 and 7, the magnetic storage device include a housing 123. A motor 124, a hub 125, a plurality of recording and reproducing heads 127, a plurality of suspension 128, a plurality of arms 129 and an actuator unit 121 are provided in the housing 123. The magnetic recording medium 126 is provided at the hub 125 rotated by the motor 124. The recording and reproducing head 127 includes a multiple type head of a play back head of a MR (magnetic resistance effective type) element, a GMR (giant magnetic resistance effective type) element or a TMR (tunnel magnetic resistance effective type) element and a recording head of a thin film head. The record and reproducing head 127 is equipped at a head end of the arm 129 corresponding to the recording and reproducing head 127 by a suspension 128. The arm 129 is driven by an actuator unit 121. Since the basic structure of the magnetic storage device is well known, description of details of the magnetic storage device will be omitted.

This embodiment of the magnetic storage device 120 has a special feature with respect to the magnetic recording medium 126. The respective magnetic recording media have structures as described in the first and second embodiments shown with FIGS. 1 and 2.

The present invention is not limited to these embodiments, but variations and modifications may be made without departing from the scope of the present invention. For example, a basic structure of the magnetic storage device 120 is not limited to the disclosure in FIGS. 6 and 7. In addition, the magnetic recording medium 126 in the present invention is not limited to a magnetic disk. The number of the magnetic recording medium 126 disks is not limited to three but may be one, two, four or more.

This patent application is based on Japanese priority patent application No. 2002-016135 filed on Jan. 24, 2002, the entire contents of which are hereby incorporated by reference.

What is claimed is:

1. A magnetic recording medium, comprising:
a substrate; and
a recording layer and a protection layer that are provided upward of the substrate,
wherein the recording layer includes a magnetic layer ; and
the magnetic layer includes a CoCrPt group alloy and an additive chemical element selected from a group comprising chemical elements in which a standard electrode electric potential is negative and platinum group chemical elements other than Pt.

2. The magnetic recording medium as claimed in claim 1,
wherein the magnetic layer includes 0.01 at % through 30 at % of the additive chemical element.

3. The magnetic recording medium as claimed in claim 1,
wherein the recording layer includes a plurality of the magnetic layers; and a non-magnetic connection layer is provided between each of the magnetic layers.

4. The magnetic recording medium as claimed in claim 2,
wherein the recording layer includes a plurality of the magnetic layers, and a non-magnetic connection layer is provided between each of the magnetic layers.

5. The magnetic recording medium as claimed in claim 1,
wherein the protection layer has a layer thickness of 0.5 nm through 10 nm.

6. The magnetic recording medium as claimed in claim 2,
wherein the protection layer has a layer thickness of 0.5 nm through 10 nm.

7. The magnetic recording medium as claimed in claim 3,
wherein the protection layer has a layer thickness of 0.5 nm through 10 nm.

8. The magnetic recording medium as claimed in claim 1,
wherein the magnetic layer includes the CoCrPt group alloy and the additive chemical element selected from a group comprising P, Ru, Os, Rh, Ir, Pd, Ba, Sr, Ca, Ti, Mn, Fe, Ni, and La.

9. The magnetic recording medium as claimed in claim 2,
wherein the magnetic layer includes the CoCrPt group alloy and the additive chemical element selected from a group comprising P, Ru, Os, Rh, Ir, Pd, Ba, Sr, Ca, Ti, Mn, Fe, Ni, and La.

10. The magnetic recording medium as claimed in claim 3,
wherein the magnetic layer includes the CoCrPt group alloy and the additive chemical element selected from a group comprising P, Ru, Os, Rh, Ir, Pd, Ba, Sr, Ca, Ti, Mn, Fe, Ni, and La.

11. The magnetic recording medium as claimed in claim 5,
wherein the magnetic layer includes the CoCrPt group alloy and the additive chemical element selected from a group comprising P, Ru, Os, Rh, Ir, Pd, Ba, Sr, Ca, Ti, Mn, Fe, Ni, and La.

12. A magnetic storage device including a magnetic recording medium, the magnetic recording medium comprising:
a substrate; and
a recording layer and a protection layer that are provided upward of the substrate,
wherein the recording layer includes a magnetic layer ; and
the magnetic layer includes a CoCrPt group alloy and an additive chemical element selected from a group comprising chemical elements in which a standard electrode electric potential is negative and platinum group chemical elements other than Pt.

13. The magnetic storage device as claimed in claim 12,
wherein the magnetic layer includes 0.01 at % through 30 at % of the additive chemical element.

14. The magnetic recording medium as claimed in claim 12,
wherein the recording layer includes a plurality of the magnetic layers, and a non-magnetic connection layer is provided between each of the magnetic layers.

15. The magnetic recording medium as claimed in claim 12,
wherein the protection layer has a layer thickness of 0.5 nm through 10 nm.

16. The magnetic recording medium as claimed in claim 12,
wherein the magnetic layer includes the CoCrPt group alloy and the additive chemical element selected from a group comprising P, Ru, Os, Rh, Ir, Pd, Ba, Sr, Ca, Ti, Mn, Fe, Ni, and La.
